(19) United States
(12) Patent Application Publication
(10) Pub. No.: US 2013/0228104 A1
(43) Pub. Date: Sep. 5, 2013

(54) CASHBOX SYSTEM, CASHBOX APPARATUS AND MANAGEMENT METHOD BY CASHBOX APPARATUS

(71) Applicant: TOSHIBA TEC KABUSHIKI KAISHA, Tokyo (JP)

(72) Inventors: Akiko Susaki, Tokyo-to (JP); Tsuyoshi Gotanda, Tokyo-to (JP); Keiichi Hasegawa, Tokyo-to (JP); Nobuhiro Sugita, Shizuoka-ken (JP)

(73) Assignee: TOSHIBA TEC KABUSHIKI KAISHA, Tokyo (JP)

(21) Appl. No.: 13/785,388

(22) Filed: Mar. 5, 2013

(30) Foreign Application Priority Data
Mar. 5, 2012 (JP) 2012-048321

(51) Int. Cl. E05G 1/00

(52) U.S. Cl. CPC E05G 1/005
USPC 109/23

(57) ABSTRACT

A generation section, a first output section, a lock control section and a second output section. The cashbox apparatus includes a storage unit configured to receive a currency storage tool for storing currency, a door configured to open and close the storage unit, a locking device configured to lock and unlock the door, a detection section configured to detect the status of the door and an input section configured to input a first personal identification information. The generation section generates a second personal identification information. The first output section outputs the second personal identification information generated by the generation section. The lock control section enables the locking device to unlock if the second personal identification information generated by the generation section matches with the first personal identification information input by the input section. The second output section outputs the detection result of the detection section.

### CROSS-REFERENCE TO RELATED APPLICATION

This application is based upon and claims the benefit of priority from Japanese Patent Application No. 2012-048321, filed Mar. 5, 2012, the entire contents of which are incorporated herein by reference.

### FIELD

Embodiments described herein relate to a cashbox system, a cashbox apparatus and a method.

### BACKGROUND

Conventionally, a cashbox system in which a checkout apparatus comprising a POS terminal and an automatic change dispensing machine, and a cashbox apparatus are connected to be capable of carrying out communication is known. In the cashbox system, a sales amount dispensed from the automatic change dispensing machine is stored in a cashbox by a shop clerk.

### BRIEF DESCRIPTION OF THE DRAWINGS

FIG. 1 is a system structure view illustrating a management system according to a first embodiment;

FIG. 2 is an external perspective view illustrating a checkout apparatus according to the first embodiment;

FIG. 3 is a block diagram illustrating an automatic change dispensing machine according to the first embodiment;

FIG. 4 is an external perspective view illustrating a collection cassette according to the first embodiment;

FIG. 5 is a perspective view illustrating a portion of a back wall of the collection cassette according to the first embodiment, which is observed from the side of a back surface;

FIG. 6 is a block diagram illustrating a hardware structure of the checkout apparatus according to the first embodiment;

FIG. 7 is an external perspective view illustrating a cashbox apparatus according to the first embodiment;

FIG. 8 is a perspective view illustrating a storage unit of the cashbox apparatus according to the first embodiment;

FIG. 9 is a longitudinal sectional side view illustrating the storage unit of the cashbox apparatus according to the first embodiment;

FIG. 10 is a perspective view illustrating a portion of a rear wall of an individual storage unit according to the first embodiment, which is observed from the side of a front surface;

FIG. 11 is a perspective view illustrating a part of a locking device according to the first embodiment;

FIG. 12 is a block diagram illustrating a hardware structure of the cashbox apparatus according to the first embodiment;

FIG. 13 is a plan view illustrating a personal identification information ticket according to the first embodiment;

FIG. 14 is a flow chart illustrating a flow of the personal identification information output processing executed by the checkout apparatus according to the first embodiment;

FIG. 15 is a flow chart illustrating a flow of the recovery processing executed by the cashbox apparatus according to the first embodiment;

FIG. 16 is a block diagram illustrating the hardware structure of the checkout apparatus according to a second embodiment; and

FIG. 17 is a block diagram illustrating the hardware structure of the cashbox apparatus according to the second embodiment.

### DETAILED DESCRIPTION

In accordance with an embodiment, a cashbox system comprises a cashbox apparatus, a generation section, a first output section, a lock control section and a second output section. The cashbox apparatus includes a storage unit configured to receive a currency storage tool for storing currency, a door configured to open and close the storage unit, a locking device configured to lock and unlock the door, a detection section configured to detect the status of the door and an input section configured to input a first personal identification information. The generation section generates a second personal identification information. The first output section outputs the second personal identification information generated by the generation section. The lock control section enables the locking device to unlock if the second personal identification information generated by the generation section matches with the first personal identification information input by the input section. The second output section outputs the detection result of the detection section.

Hereinafter, a cashbox system, a cashbox apparatus and a management method according to the embodiment are described in detail with reference to the accompanying drawings. In addition, in a plurality of the following embodiments, same or similar components are included. Therefore, in the following descriptions, these same components are applied with common symbols or numerals, and the repeated descriptions thereof are omitted.

### A First Embodiment

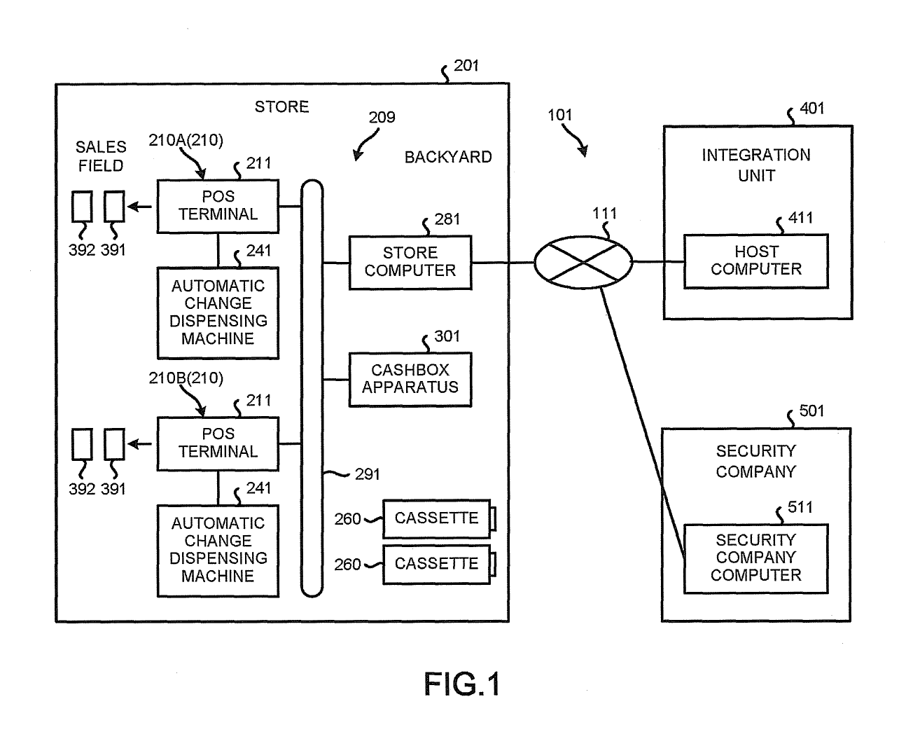

FIG. 1 is a system structure view illustrating a management system 101 according to the present embodiment. The management system 101 includes a store computer 281 set in a store or shop 201, a host computer 411 set in an integration section 401 for unifying each store 201, and a security company computer 511 set in a security company 501 in charge of the security and the like for each store 201 according to a contract. The store computer 281, the host computer 411 and the security company computer 511 are connected through a communication network 111 to be capable of carrying out a mutual data communication.

The store computer 281 is configured in a backyard of the store 201. A plurality of POS terminals 211 are connected with the store computer 281 through a LAN cable 291. The POS terminals 211 are installed in a sales floor of the store 201. An automatic change dispensing machine 241 is connected with each POS terminal 211 to be capable of carrying out the data communication. The POS terminals 211 and the automatic change dispensing machine 241 constitute a checkout apparatus 210. Moreover, the checkout apparatus 210 and the store computer 281 constitute the cashbox system 209. In the present embodiment, a first checkout apparatus 210A and a second checkout apparatus 210B are arranged as the checkout apparatus 210. Moreover, the cashbox apparatus 301 is connected with the store computer 281 and the POS terminals 211 through the LAN cable 291 to be capable of carrying out the data communication. The checkout apparatus 210 is an example of an information processing apparatus generating a personal identification number. More particularly, the POS terminal 211 in the checkout apparatus 210 is an example of the information processing apparatus generating a personal identification number.

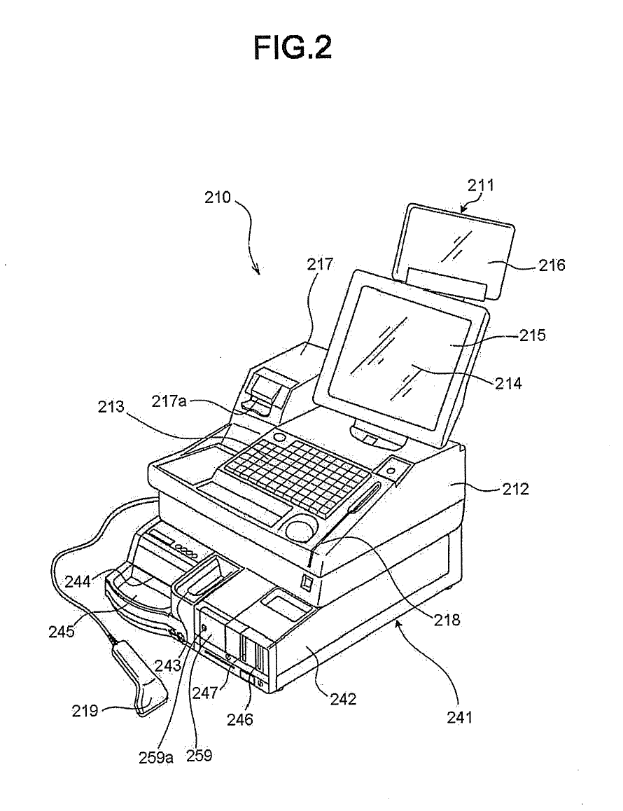

FIG. 2 is an external perspective view illustrating the checkout apparatus 210 according to the present embodiment. The POS terminal 211 is placed on the automatic change dispensing machine 241. The automatic change dispensing machine 241 is arranged on a checkout counter (not shown in figures) in the sales floor.

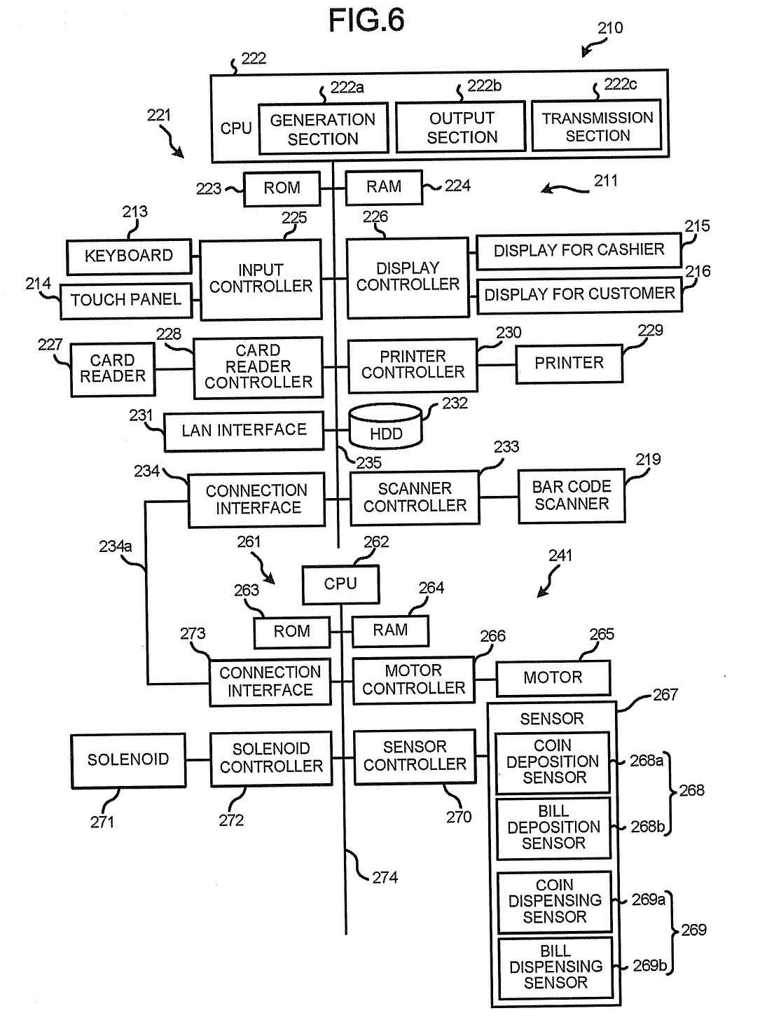

The POS terminal 211 comprises a housing 212 which arranges each portion of the POS terminal at the outside or inside thereof. A keyboard 213 is arranged on the upper surface of the housing 212. The keyboard 213 comprises a numeric key or a ten-key on which numerals are respectively marked, a temporary closing key on which the “sub-total” is denoted, a closing key on which a “deposit/cash total” is denoted, a collection key on which the “collection” is denoted, and the like. A display 215 with an information display function for a cashier is arranged at a position above the keyboard 213. As an example, the display 215 is a liquid crystal display. A touch panel 214 is set on the screen of the display 215. A printer cover 217 is arranged at the left side of the display 215. An issue port 217a is formed on the front surface of the printer cover 217. A printer 229 (referring to FIG. 6) is set inside the printer cover 217. The printer 229 is an example of an output apparatus. As an example, the printer 229 prints a specified matter on a sheet and issues a receipt. A card slit 218 is formed at the right side of the keyboard 213. The card slit 218 is used for reading of the card information carried out by a card reader 227 (referring to FIG. 6) built in the housing 212.

A display 216 serving as a display unit with the information display function for a customer is arranged at the side of the back surface of the display 215 at a position higher than the display 215. The display 216 is mounted on a supporting column protruding from the housing 212 in a rotatable manner. As an example, the display 216 is the liquid crystal display. In addition, the POS terminal 211 has a bar code scanner 219. The bar code scanner 219 reads out a commodity code or a bar code attached to a commodity.

The automatic change dispensing machine 241 comprises a housing 242 which arranges each portion of the machine 241 at the outside or inside thereof. A bill input port 246 for allowing depositing a bill is formed at the right side of the front surface of the housing 242. A bill dispensing port 247 for dispensing the bill is formed at the left side of the bill input port 246. A coin input port 243 which is open upwards is formed at the center of the side of the front surface of the housing 242. The coin input port 243 allows the input of a plurality of coins at a time. A coin dispensing port 244 for dispensing a coin and a coin receiving tray 245 for receiving a coin dispensed from the coin dispensing port 244 are arranged at the left side of the coin input port 243. Moreover, a cover 259 is arranged at the left side of the bill dispensing port 247 of the housing 242 in a detachable manner. The locking device 259a is arranged on the cover 259. The locking device 259a carries out the locking and the unlocking of the cover 259. A storage unit (not shown in the figures) is arranged at the inner side of the housing 242 and the cover 259, and the storage unit receives a collection cassette 260 in the manner that the collection cassette 260 (referring to FIG. 4) for collecting a bill or a bank note can be taken out.

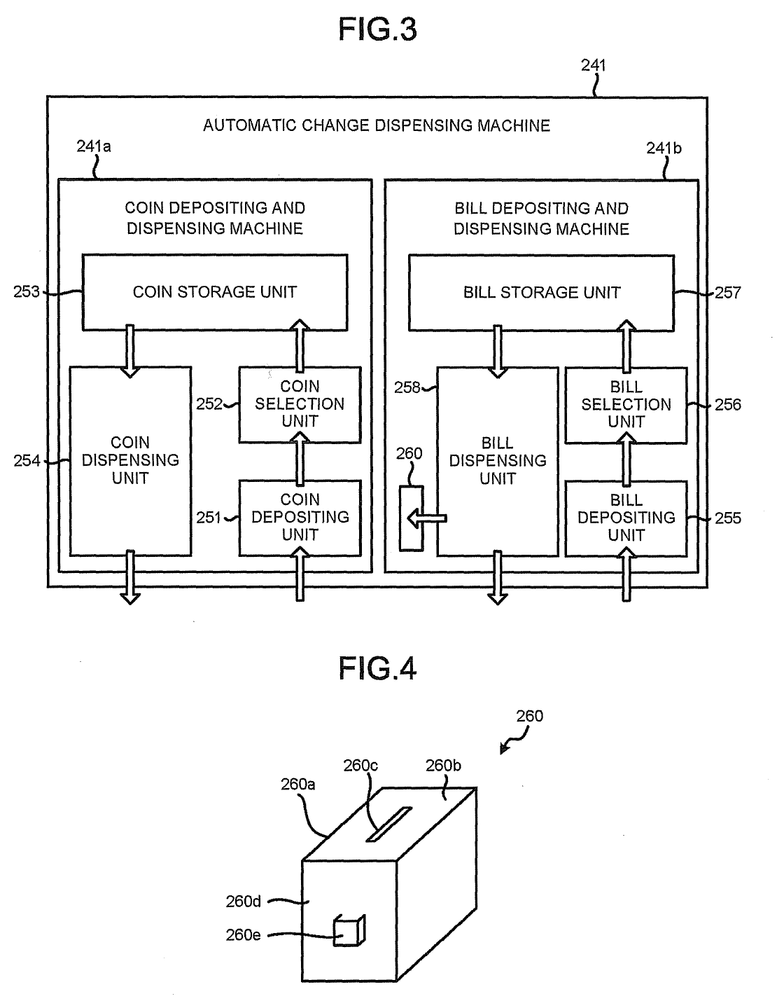

FIG. 3 is a functional block diagram illustrating the automatic change dispensing machine 241 according to the present embodiment. The automatic change dispensing machine 241 comprises a coin depositing and dispensing unit 241a with a depositing and dispensing function for a coin (a 1-yen coin, a 5-yen coin, a 10-yen coin, a 50-yen coin, a 100-yen coin and 500-yen coin), and a bill depositing and dispensing unit 241b with the depositing and dispensing function for a bill (a 1000-yen bill, a 5000-yen bill and a 10000-yen bill).

First, the coin depositing and dispensing unit 241a is described. The coin depositing and dispensing unit 241a comprises a coin depositing unit 251 serving as a currency depositing unit, a coin selection unit 252, a coin storing unit 253 serving as a currency storing unit, and a coin dispensing unit 254 serving as a currency dispensing unit. The coin depositing unit 251 includes the coin input port 243 (referring to FIG. 2) and allows reception of a coin through the coin input port 243 to convey the coin to the inside thereof. The coin selection unit 252 sorts the coin which is received by the coin depositing unit 251 according to a denomination during the conveyance by the coin depositing unit 251. The coin storing unit 253 stores the coin sorted by the coin selection unit 252 according to a denomination category. The coin dispensing unit 254 includes the coin dispensing port 244 and the coin receiving tray 245 (referring to FIG. 2) and dispenses the coin stored in the coin storing unit 253 through the coin dispensing port 244 according to a dispensing instruction from the POS terminal 211.

Moreover, the coin depositing and dispensing unit 241a has a coin depositing sensor 268a (referring to FIG. 6) serving as a depositing detection device set in the coin selection unit 252 according to the respective denomination to detect the received coin, and has a coin dispensing sensor 269a (referring to FIG. 6) serving as a dispensing detection device set in the coin dispensing unit 254 according to the respective denomination to detect the dispensed coin.

Next, the bill depositing and dispensing unit 241b is described. The bill depositing and dispensing unit 241b comprises a bill depositing unit 255 serving as the currency depositing unit, a bill selection unit 256, a bill storing unit 257 serving as the currency storing unit, and a bill dispensing unit 258 serving as the currency dispensing unit. The bill depositing unit 255 includes the bill input port 246 (referring to FIG. 2) and allows reception of a bill through the bill input port 246 to convey the bill to the inside thereof. The bill selection unit 256 sorts the bill which is received by the bill depositing unit 255 according to the denomination during the conveyance by the bill depositing unit 255. The bill dispensing unit 258 includes the bill dispensing port 247 (referring to FIG. 2) and dispenses the bill stored in the bill storing unit 257 through the bill dispensing port 247 according to the dispensing instruction from the POS terminal 211. Moreover, as an example, the bill dispensing unit 258 dispenses the bill stored in the bill storing unit 257 towards the collection cassette 260 according to a collection instruction from the POS terminal 211.

The bill depositing and dispensing unit 241b has a bill depositing sensor 268b (referring to FIG. 6) serving as a depositing detection device set in the bill selection unit 256 to detect the deposited bill, and has a bill dispensing sensor 269a (referring to FIG. 6) serving as a dispensing detection device set in the bill dispensing unit 258 to detect the dispensed bill.

For the structures and the like of the coin depositing unit 251, the coin selection unit 252, the coin storing unit 253, the coin dispensing unit 254, the bill depositing unit 255, the bill selection unit 256, the bill storing unit 257 and the bill dispensing unit 258 of such an automatic change dispensing machine 241, their contents are known, and therefore, the descriptions thereof are omitted.

Hereinafter, the coin depositing sensor 268a and the bill depositing sensor 268b may collectively be called as a deposition sensor 268. Also, the coin dispensing sensor 269a and the bill dispensing sensor 269b may collectively be called as a dispensing sensor 269.

FIG. 4 is an external perspective view illustrating the collection cassette 260 according to the present embodiment. As shown in FIG. 4, the collection cassette 260 has a main body unit 260a in a rectangular box shape. A depositing port 260c is provided on the upper surface 260b of the main body unit 260a. A bill is deposited from the depositing port 260c to the inside of the main body unit 260a. A dispensing port (not shown in the figures) which dispenses a bill is formed on the main body unit 260a. The dispensing port is covered by a cover (not shown in the figures), and the cover is locked by the locking device (not shown in the figures). Moreover, a pocket 260e is formed on the front surface 260d of the main body unit 260a.

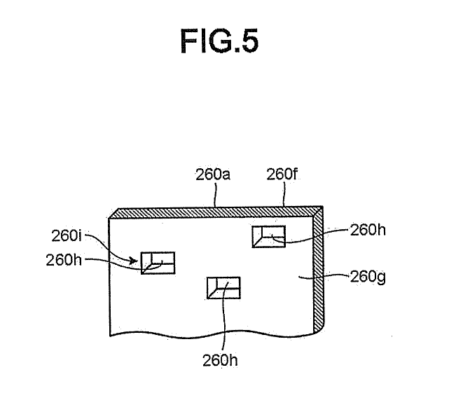

FIG. 5 is a perspective view illustrating a portion of a back wall 260f of the collection cassette 260 according to the present embodiment, which is observed from the side of a back surface 260g. As shown in FIG. 5, a clamping unit 260i is provided on the back surface 260g (outside surface of the back wall 260f) of the collection cassette 260. The clamping unit 260i has a plurality of recesses (female keys) 260h. The clamping unit 260i is an example of a second clamping unit. The clamping unit 260i (collection cassette 260) includes a plurality of varieties according to the difference in shape thereof. An example of the difference in shape of the clamping unit 260i is the difference in position of the recess 260h. Different varieties of the collection cassette 260 are provided among a plurality of checkout apparatuses 210. In other words, different varieties of the collection cassette 260 are prepared for the plurality of POS terminals 211. Different varieties of the collection cassette 260 are provided for a plurality of automatic change dispensing machines 241. Moreover, a plurality of collection cassettes 260 of the same variety are provided for one checkout apparatus 210 (POS terminal 211, automatic change dispensing machine 241). As an example, one of the plurality of collection cassettes 260 is set in the automatic change dispensing machine 241, and other collection cassettes 260 are kept near the cashbox apparatus 301 as the collection cassettes for replacement in the backyard of the store 201 (referring to FIG. 1). The collection cassette 260 is an example of a currency receiving tool for storing a currency.

FIG. 6 is a block diagram illustrating a hardware structure of the checkout apparatus 210 according to the present embodiment.

As shown in FIG. 6, the POS terminal 211 comprises a control unit 221 for drive-controlling each portion or section of the POS terminal 211. The control unit 221 is composed of a ROM 223 for previously storing fixed data such as a control program and the like and a RAM 224 for storing various data in a rewritable manner to function as a work area and the like are connected with a CPU 222 for centrally controlling each portion of the POS terminal 211 through a bus line 235. Therefore, the control unit 221 constitutes an information processing unit executing information processing. A part of the RAM 224 is a non-volatile memory in which a stored content is not vanished even though a power supply to the POS terminal 211 is cut off.

In the control unit 221, an input controller 225 connected with the keyboard 213 and the touch panel 214, a display controller 226 connected with the displays 215 and 216, a card reader controller 228 connected with the card reader 227, a printer controller 230 connected with the printer 229, a scanner controller 233 connected with the bar code scanner 219, an LAN interface 231, a connection interface 234 and an HDD 232 are connected through the bus line 235.

The control unit 221 acquires an input signal from the keyboard 213 or the touch panel 214 by the input controller 225. The display controller 226 drives the display 215 or the display 216 based on an image data and displays an image corresponding to the image data on the display 215 or the display 216. The card reader controller 228 drives the card reader 227, and the control unit 221 acquires card information and the like read by the card reader 227. The printer controller 230 carries out the printing corresponding to printing data on the sheet. The scanner controller 233 drives the bar code scanner 219, and the control unit 221 acquires the commodity code read by the bar code scanner 219. The data communication with the store computer 281 through the LAN cable 291 (referring to FIG. 1) is carried out by the LAN interface 231. The connection interface 234 is connected with a connection interface 273 of the automatic change dispensing machine 241 through a communication cable 234a. That is, the data communication with the automatic change dispensing machine 241 through the communication cable 234a is carried out by the connection interface 234. The HDD 232 stores various files such as an operation or application program, a PLU file, an image file, a sound file, a sales file and the like. All or part of these programs, various files and the like are transferred to the RAM 224 to be used when the POS terminal 211 is started. The PLU file stores a unit price and the like corresponding to the commodity code for specifying each commodity in a rewritable manner. The PLU file is distributed from the store computer 281 (referring to FIG. 1) to be stored in the HDD 232.

The control unit 221 of the POS terminal 211 constituted in such a manner executes commodity sales data processing including retrieval processing and checkout processing.

The retrieval processing is the following processing that, in case that a bar code attached to the commodity is read by the bar code scanner 219, the commodity code represented by the read bar code is recognized, and the PLU file is retrieved, so as to acquire a unit price, a weight and a commodity display corresponding to the commodity code.

The checkout processing is the processing that a total amount that a customer should pay is calculated based on the unit price acquired in the retrieval processing and the checkout of the total amount is executed. The total amount is provisionally registered in the RAM 224 or is registered in the sales file. In the checkout processing, a checkout amount (equal to or greater than the total amount) from the customer is received and is input by operating the numeric key of the keyboard 213, and a dispensed amount is determined based on the total amount and the checkout amount.

Next, the hardware structure of the automatic change dispensing machine 241 connected with the POS terminal 211 between which a data communication is carried out is described.

As shown in FIG. 6, the automatic change dispensing machine 241 includes a control unit 261 carrying out the drive control on each portion or section thereof. The control unit 261 includes a CPU 262 centrally controlling each portion or section of the machine 241, a ROM 263 previously storing the fixed data such as the control program and the like and a RAM 264 storing the various data in the rewritable manner to function as the work area and the like, which are connected through a bus line 274. Therefore, the control unit 261 constitutes an information processing unit executing the information processing. The RAM 264 includes a non-volatile memory in which the stored content is not vanished even though a power supply to the automatic change dispensing machine 241 is cut off. A balance file for storing the current amount of the currency stored in the coin storing unit 253 (referring to FIG. 3) and the bill storing unit 257 (referring to FIG. 3) is formed in the RAM 264.

In the control unit 261, a motor controller 266 connected with a motor 265, a solenoid controller 272 connected with a solenoid 271, a sensor controller 270 connected with a sensor set 267 including a deposition sensor 268 and a dispensing sensor 269, and the connection interface 273 are connected through the bus line 274.

The motor controller 266 drives the motor 265 to rotate the motor 265. The motor 265 is a drive source for rotating a conveyor belt (not shown in the figures) arranged at the inside of the automatic change dispensing machine 241. The conveyor belt is provided in the coin depositing unit 251, the coin dispensing unit 254, the bill depositing unit 255, the bill dispensing unit 258 and the like, and the depositing and the dispensing of the currency, which are carried out for the automatic change dispensing machine 241, are carried out by the rotation of the conveyor belt. The solenoid controller 272 drives the solenoid 271 to shift the solenoid 271. The solenoid 271 is provided in the coin dispensing unit 254 and carries out the dispensing of coins the number of which is instructed. The sensor controller 270 makes the control section 261 acquire the detection output of the sensor set 267. The connection interface 273 is connected with the connection interface 234 of the POS terminal 211 through the communication cable 234a. That is, the data communication with the POS terminal 211 through the communication cable 234a is carried out by the connection interface 273.

The control unit 261 of the automatic change dispensing machine 241 formed in such a manner described above specifies the denomination of the deposited currency based on the detection output of the deposition sensor 268. Moreover, the control unit 261 of the automatic change dispensing machine 241 specifies the denomination of the dispensed currency based on the detection output of the dispensing sensor 269. Contents of the processing procedures and the like specifying the denomination are well known and therefore, the descriptions thereof are omitted.

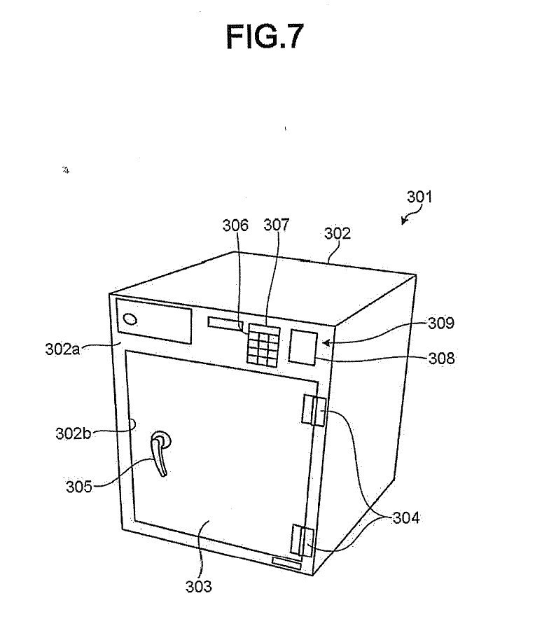

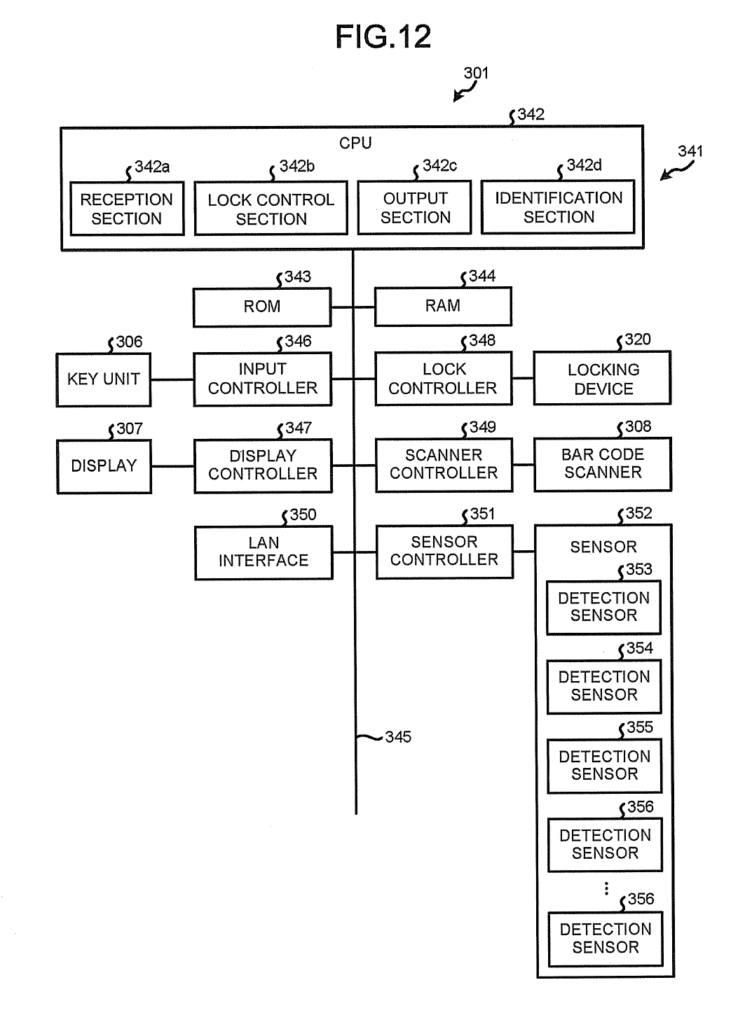

FIG. 7 is an external perspective view illustrating the cashbox apparatus 301 according to the present embodiment. As shown in FIG. 7, the cashbox apparatus 301 has a main body unit 302, a door 303 and a locking device 320 (referring to FIG. 12).

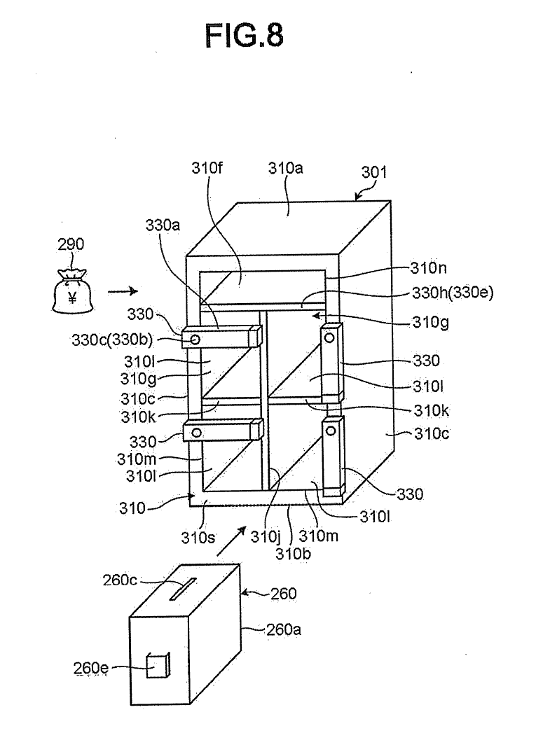

The main body unit 302 is formed in a rectangular box shape. An open unit 302b is provided on the front surface 302a of the main body unit 302. A storage unit 310 (referring to FIG. 8) is arranged inside the main body unit 302.

The door 303 is mounted on the front surface 302a of the main body unit 302 by a hinge 304. The door 303 opens and closes the storage unit 310. An opening-closing lever 305 is provided on the door 303. A user holds the opening-closing lever 305 to open or close the door 303. The door 303 is locked and unlocked by the locking device 320. As an example, the locking device 320 has a lock pin provided on the door 303, a solenoid (drive source) driving the lock pin to carry out a reciprocating action of the lock pin, and an clamping recess, arranged on the main body unit 302, with which the lock pin is engaged. The locking device 320 carries out the locking of the door 303 when the lock pin driven by the solenoid is engaged with the clamping recess, and carries out the unlocking of the door 303 when the lock pin driven by the solenoid is disengaged with the clamping recess.

Moreover, a key unit 306, a display 307 and a bar code scanner 308 are arranged on the front surface 302a of the main body unit 302. The key unit 306, the display 307 and the bar code scanner 308 constitute an input unit 309. The input unit 309 is an example of the input element for inputting a personal identification number serving as the personal identification information. The key unit 306 has a numeric key, an enter key and the like. As an example, the display 307 is a liquid crystal display. As an example also, the bar code scanner 308 reads the personal identification number denoted in the bar code. Particularly, the bar code scanner 308 reads the bar code 391b denoted on the following personal identification information ticket 391. The personal identification number is an example of the personal identification information. The personal identification information may be a character except a numeral and may also be the combination of a numeral and a character.

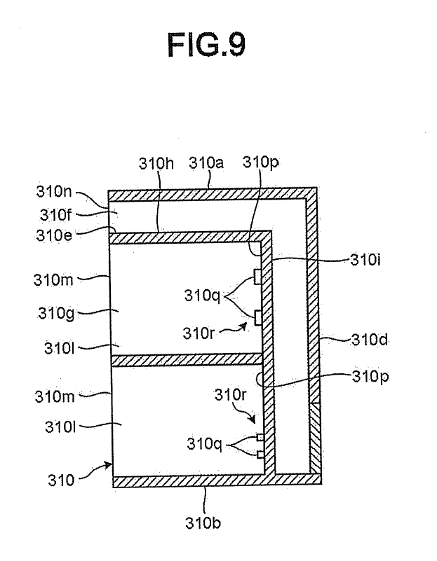

FIG. 8 is a perspective view illustrating the storage unit 310 of the cashbox apparatus 301 according to the present embodiment, and FIG. 9 is a longitudinal sectional side view of the storage unit 310 of the cashbox apparatus 301 according to the present embodiment. As shown in FIG. 8 and FIG. 9, the storage unit 310 is formed in the rectangular box shape and the front surface thereof is open. The storage unit 310 stores a collection bag 290 (FIG. 8) and the collection cassette 260 (FIG. 8). The storage unit 310 has an upper wall 310a, a lower wall 310b, one pair of side walls 310c and a rear wall 310d. The inside of the storage unit 310 is divided by a partition wall 310e into a coin storage unit 310f and a bill storage unit 310g. The partition wall 310e has a first portion 310h and a second portion 310I (FIG. 9). The first portion 310h is arranged along the upper wall 310a, and the second portion 310I extends downwards from the rear end of the first portion 310h along the rear wall 310b and comes to the lower wall 310b.

The coin storage unit 310f stores the collection bag 290 (FIG. 8). An open section 310n is formed on the front surface of the coin storage unit 310f, and the collection bag 290 is taken out of the open section 310n of the coin storage unit 310f. As an example, the collection bag 290 stores the coin dispensed by the automatic change dispensing machine 241 according to the collection instruction. The collection bag 290 is an example of the currency storing tool for storing the currency.

The bill storage unit 310g stores the collection cassette 260. The bill storage unit 310g is divided into a plurality of individual storage units 310I by a longitudinal partition wall 310j and a transverse partition wall 310k. As an example, the individual storage unit 310I is provided according to the configuration of two lines and two rows. As an example, two individual storage units 310I at an upper layer in the plurality of individual storage units 310I are used for the first checkout apparatus 210A, and two individual storage units 310I at a lower layer in the plurality of individual storage units 310I are used for the second checkout apparatus 210B. The individual storage unit 310I stores the collection cassette 260. Open sections 310m are provided on the front surfaces of the individual storage units 310I, and the collection cassette 260 is taken out of the open section 310m of the individual storage unit 310I.

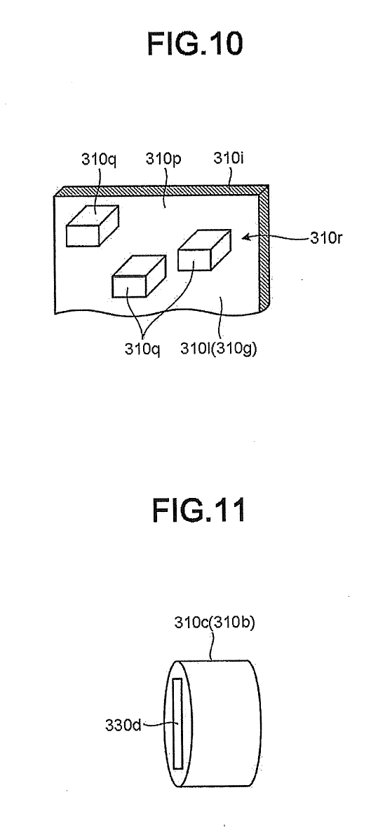

FIG. 10 is a perspective view illustrating a portion of a rear wall of the individual storage unit 310I according to the first embodiment, which is observed from the side of a front surface. As shown in FIG. 10, a clamping unit 310r is provided on the internal surface 310p of the rear wall of the individual storage unit 310I. The clamping unit 310r has a plurality of convex potions (external keys) 310q. The clamping unit 310r is an example of a first clamping unit. The clamping unit 310r (individual storage unit 310I) includes a plurality of varieties thereof. The difference of the varieties of the clamping unit 310r is the difference in the position of the convex portion 310q. The clamping unit 310r provided in the two individual storage units 310I at the upper layer engages with the clamping unit 260i of the collection cassette 260 of the first checkout apparatus 210A and does not engage with the clamping unit 260i of the collection cassette 260 of the second checkout apparatus 210B. On the other hand, the clamping unit 310r provided in the two individual storing units 310I at the lower layer engages with the clamping unit 260i of the collection cassette 260 of the second checkout apparatus 210B and does not engage with the clamping unit 260i of the collection cassette 260 of the first checkout apparatus 210A. In the individual storage unit 310I, in case that the clamping unit 310r engages with the clamping unit 260i provided on the collection cassette 260, the whole collection cassette 260 is stored inside the individual storage unit 310I, and a restriction bar 330a described later positions at a stop position and can carry out a movement-restriction by a restriction unit 330. On the other hand, in case that the clamping unit 310r does not engage with the clamping unit 260i provided in the collection cassette 260, the collection cassette 260 is in a state such that a portion thereof protrudes from the open section 310m of the individual storing unit 310I. In such a case, the restriction bar 330a cannot be positioned at the stop position, and the restriction unit 330 cannot carry out the movement-restriction.

Moreover, as shown in FIG. 8, the restriction unit 330 is provided on the individual storage unit 310I. The restriction unit 330 is provided each individual storage unit 310I. The restriction unit 330 restricts the takeout of the collection cassette 260 from the individual storage unit 310I. The restriction unit 330 has the restriction bar 330a and a locking device 330b.

The restriction bar 330a is provided in a rotatable manner on the front surface 310s of the storage unit 310 constituting the front surface of the individual storage unit 310I. The restriction bar 330a is rotatable between a restriction position (the position of two restriction bars 330a on a left side in FIG. 8) and a releasing position (the position of two restriction bars 330a on a right side in FIG. 8). The restriction position is a position where the restriction bar 330a traverses the open section 310m of the storage unit 310, so as to restrict the takeout and the receipt of the collection cassette 260 from and into the individual storage unit 310I. The releasing position is a position where the restriction bar 330a releases the open section 310m, so as to allow the takeout and the receipt of the collection cassette 260 from and into the individual storage unit 310I. The locking device 330b carries out the locking and the unlocking of the restriction bar 330a. The locking device 330b locks the restriction bar 330a positioned at the restriction position. The locking device 330b has an operation unit 330c which can be pressed into against the restriction bar 330a. The locking device 330b locks the restriction bar 330a by carrying out a pressing operation on the operation unit 330c by an operator while the restriction bar 330a is positioned at the restriction position. Moreover, as shown in FIG. 11, a keyhole 330d is provided on the operation unit 330c. The locking device 330b unlocks the restriction bar 330a by the rotation of a key (not shown in the figures) inserted into the keyhole 330d. Thus, in the restriction unit 330, the above-described restriction carried out by the restriction bar 330a can be released by the key, and moreover, the above-described restriction by the restriction bar 330a can be carried out by a manual operation. Such a locking device 330b is a so-called push-type locking device, and since its structure is known, the detailed description thereof is omitted.

FIG. 12 is a block diagram illustrating a hardware structure of the cashbox apparatus 301 according to the present embodiment.

As shown in FIG. 12, the cashbox apparatus 301 includes a control unit 341 carrying out the drive control on each portion or section of the cashbox apparatus 301. The control unit 341 is composed of a ROM 343 previously storing the fixed data such as the control program and the like and a RAM 344 storing the various data in the rewritable manner to function as the work area and the like which are connected with a CPU 342 centrally controlling each portion or section through a bus line 345. Therefore, the control unit 341 constitutes the information processing unit executing the information processing. The RAM 344 includes a non-volatile memory in which the stored content is not vanished even though a power supply to the cashbox apparatus 301 is cut off.

In the control unit 341, an input controller 346 connected with the key unit 306, a display controller 347 connected with the display 307, a lock controller 348 connected with the locking device 320, a scanner controller 349 connected with the bar code scanner 308, a sensor controller 351 and a LAN interface 350 are connected through the bus line 345.

The control unit 341 acquires an input signal from the key unit 306 by the input controller 346. The display controller 346 carries out the drive control on the display 307 based on the image data and displays the image corresponding to the image data on the display 307. The lock controller 348 carries out the drive control on the locking device 320 and enables the locking device 320 to execute the locking and the unlocking. The scanner controller 349 carries out the drive control on the bar code scanner 308 to read a bar code and the control unit 341 acquires the bar code read by the bar code scanner 308. The LAN interface 350 carries out the data communication with the store computer 281 and the POS terminal 211 through the LAN cable 291 (referring to FIG. 1).

Moreover, a sensor set 352 is connected with the CPU 342 through the bus line 345 and the sensor controller 351. A plurality of detection sensors 353-356 are included in the sensor set 352. The control unit 341 acquires detection outputs (detection results) of the sensor set 352 by the sensor controller 351.

The detection sensor 353 detects the status of the door 303. The detection sensor 353 is an example of the detection element (a first detection element). The detection sensor 353 detects the locking and the unlocking of the door 303 as the status of the door 303. As an example, the detection sensor 353 is provided in the clamping recess of the locking device 320 and detects the existence of the lock pin in the clamping recess. The detection sensor 353, for example, is an optical sensor or a micro-switch and the like.

The detection sensor 354 detects the opening/closing status of the door 303 as the status of the door 303. As an example, the detection sensor 354 is arranged at the edge portion of the open section 302b in the main body unit 302 and detects the existence of the door 303 in the open section 302b. The detection sensor 354, for example, is the optical sensor or the micro-switch and the like.

The detection sensor 355 detects the above-described restriction by the restriction unit 330. The detection sensor 355 is an example of a second detection element. The detection sensor 355, for example, is provided on the wall surface of the individual storage unit 310I and detects whether or not the restriction bar 330a is positioned at the restriction position. Thus, the detection sensor 355 detects whether or not the restriction bar 330a performs the above restriction.

The detection sensor 356 is provided on each individual storage unit 310I. The detection sensor 356 detects whether or not the collection cassette 260 is received in the individual storage unit 310I. As an example, the detection sensor 356 is provided on the internal surface 310p of the rear wall (the second portion 310i) of the individual storage unit 310I and detects the collection cassette 260 in the state that the clamping unit 260i of the collection cassette 260 engages with the clamping unit 310r. As an example, the detection sensor 356 (or the sensor controller 351) attaches the identification information of the detection sensor 356 to the result of the detection sensor 356 to input to the control unit 341.

Next, the currency collection processing in the cashbox system 209 with the above structure is described. The currency collection processing is executed as a collection key of the POS terminal 211 is operated. When the collection key is operated, the CPU 222 displays an input screen for receiving the input of the personal identification number on the display 215, and executes the currency collection processing in case that the input personal identification number is a correct one. As an example, the personal identification number is the shop clerk number of a shop clerk with an administrator authority. The CPU 222 retains the input personal identification number (the shop clerk number) in a log. Moreover, the automatic change dispensing machine 241 retains such a content that the locking device 259a of the cover 259 of the collection cassette 260 is subjected to the unlocking in the log.

In the currency collection processing, the CPU 222 of the POS terminal 211 executes personal identification information output processing. At the moment, the CPU 222 of the POS terminal 211, as shown in FIG. 6, functions as a generation section 222a, an output section 222b (the first output section) and a transmission section 222c in accordance with the program.

The generation section 222a generates the personal identification number as the personal identification information. The generation section 222a randomly generates the personal identification number. The generation section 222a encodes the personal identification number. The generation section 222a associates the personal identification with specific information for specifying the collection cassette 260. The specific information, for example, is the identification information (identification number) of the checkout apparatus 210 corresponding to the collection cassette 260, the identification information (identification number) of the POS terminal 211 or the identification information (identification number) of the automatic change dispensing machine 241. The generation section 222a associates the personal identification number with the specific information for specifying the collection cassette 260 by generating collection information including the personal identification number and the specific information for specifying the collection cassette 260.

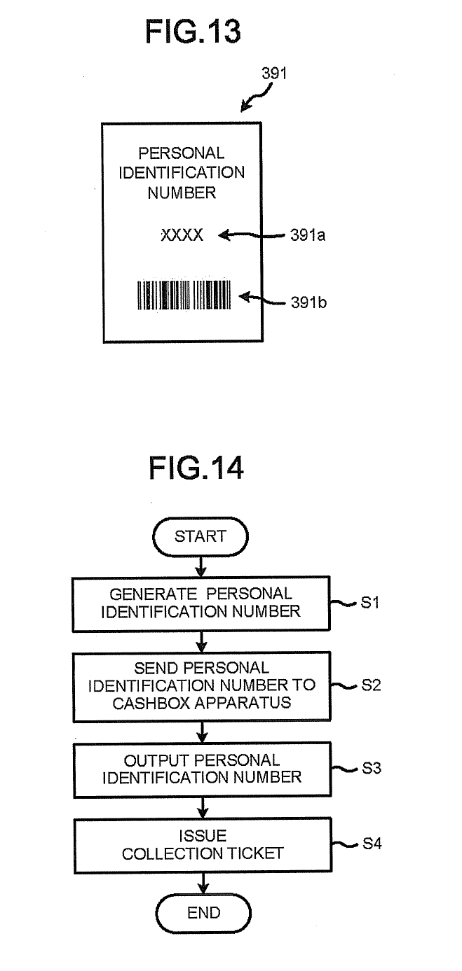

The output section 222b outputs the personal identification number generated by the generation section 222a to the printer 229. Particularly, the output section 222b outputs the personal identification information ticket 391 (referring to FIG. 13) showing the personal identification number generated by the generation section 222a to the printer 229. The printer 229 prints the specified matter on the sheet and cuts off an area in which the specified matter is printed to issue the area as the personal identification information ticket 391. As shown in FIG. 13, the personal identification information ticket 391 shows the personal identification number 391a and the bar code 391b of the personal identification number 391a. The bar code 391b is a code symbol that the personal identification number 391a is encoded.

Moreover, the output section 222b outputs a collection ticket 392 (referring to FIG. 1) to the printer 229. The collection ticket 392 shows the number of banknotes and the total amount of the banknotes stored in the collection cassette 260. The output section 222b inquires the number of banknotes and the total amount of the banknotes stored in the collection cassette 260 to the automatic change dispensing machine 241 to acquire them.

The transmission section 222c sends the personal identification number generated and encoded by the generation section 222a to the cashbox apparatus 301. Particularly, the transmission section 222c sends the collection information to the cashbox apparatus 301.

Moreover, in the currency collection processing, the CPU 342 of the cashbox apparatus 301 executes the collection processing. At the moment, the CPU 342 of the cashbox apparatus 301 functions as a reception section 342a, a lock control section 342b, an output section 342c (the second output element) and an identification section 342d in accordance with the program, as shown in FIG. 12.

The reception section 342a receives the personal identification information sent by the transmission section 222c. The reception section 342a decodes the personal identification number encoded.

The lock control section 342b enables the locking device 320 to unlock the door 303 if the personal identification information (that is, the personal identification information generated by the generation section 222a) received by the reception section 342a matches with the personal identification information input by the input section 309.

The output section 342c sends the detection result (the locking/unlocking status of the door 303) of the detection sensor 353 to the store computer 281 serving as an external apparatus of the cashbox apparatus 301. At the moment, the output section 342c sends the status information including the detection result of the detection sensor 353 to the store computer 281. The output section 342c sends information indicating the locking/unlocking status of the door 303 to the store computer 281 if the locking/unlocking status of the door 303 changes.

The identification section 342d identifies the collection cassette 260 received in the individual storage unit 310I. As an example, in the ROM 343, for the individual storing unit 310I, storage unit information for associating the identification information of the detection sensor 356 provided in the individual storage unit 310I with the identification information of the collection cassette 260 which can be received in the individual storage unit 310I for each individual storage unit 310I is stored. The identification section 342d checks the identification information of the detection sensor 356 which is given to the detection result of the detection sensor 356 detecting the collection cassette 260 with the storage unit information to acquire the identification information of the collection cassette 260 received in the individual storage unit 310I.

Next, a flow of the personal identification information output processing executed by the CPU 222 of the POS terminal 211 is described according to a flow chart shown in FIG. 14.

The CPU 222 generates the personal identification number when the collection key of the keyboard 213 is operated by the user, for example (ACT S1). At the moment, the CPU 222 outputs the collection instruction to the automatic change dispensing machine 241. The automatic change dispensing machine 241 to which the collection instruction is input dispenses a coin to the coin receiving tray 245, and moreover, dispenses a banknote to the collection cassette 260 in the manner that the specified numbers of coins and banknotes for each denomination are remained in the coin storage unit 253 and the banknote storage unit 257. The automatic change dispensing machine 241 sends dispensing information including each denomination, the number and the total amount of the dispensed currencies to the POS terminal 211. The CPU 222 receives the dispensing information.

Next, the CPU 222 sends the generated personal identification number to the cashbox apparatus 301 (ACT S2). Particularly, the CPU 222 sends the generated personal identification number and the collection information including the specific information of the collection cassette 260 provided in the POS terminal 211 with the CPU 222 to the cashbox apparatus 301.

Next, the CPU 222 outputs the generated personal identification number to the printer 229 (ACT S3). Particularly, the CPU 222 enables the printer 29 to issue the personal identification information ticket 391 showing the generated personal identification number. Next, the CPU 222 enables the printer 229 to issue the collection ticket 392 (ACT S4). The user puts the personal identification information ticket 391 and the collection ticket 392 into the pocket 260e of the collection cassette 260 taken out from the automatic change dispensing machine 241.

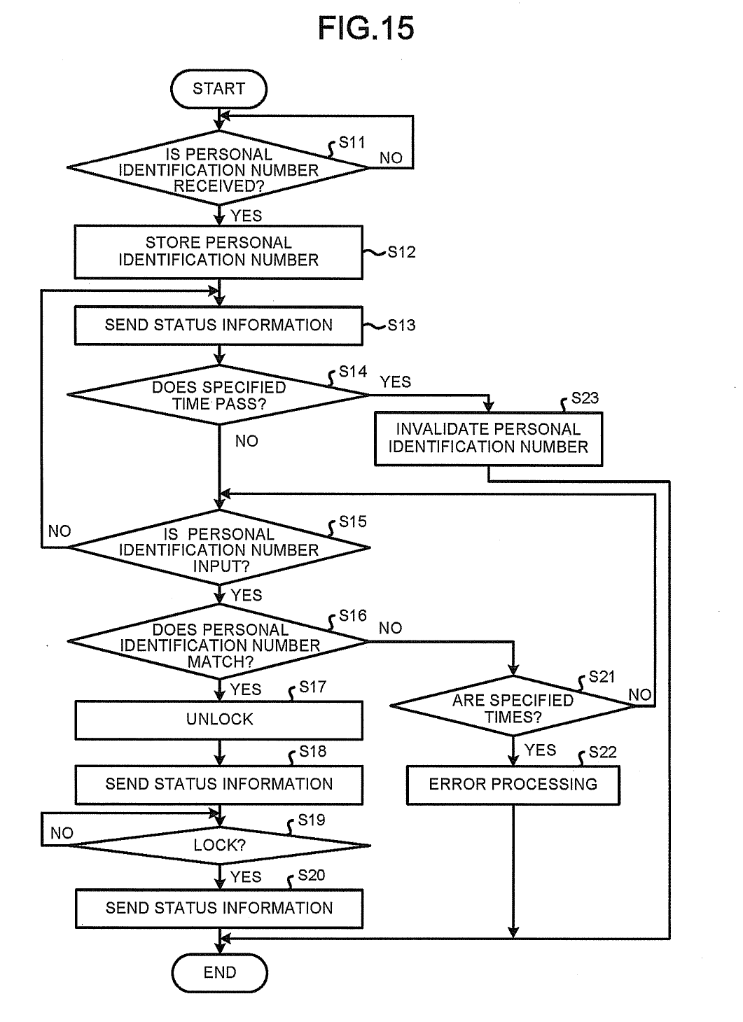

Next, a flow of the collection processing executed by the CPU 342 of the cashbox apparatus 301 is described according to a flow chart shown in FIG. 15.

The CPU 342 waits the reception of the collection information including the personal identification number sent from the POS terminal 211 (No in ACT S11). The CPU 342 stores the collection information including the personal identification number in the RAM 344 (ACT S12) when the collection information including the personal identification number is received (Yes in ACT S11).

Next, the CPU 342 sends the status information to the store computer 281 (ACT S13). In such a case, as an example, as the door 303 is kept in locked, the status information indicates that the door 303 is locked. The CPU 342 periodically sends the status information to the store computer 281 (ACT S13) during a specified period after the personal identification number is received (ACT S14, No) if the personal identification number is not inputted by the input unit 309 (No in ACT S15). IF the specified period passes after the personal identification number is received (Yes in ACT S14), the CPU 342 cancels the received personal identification number from the RAM 344 to invalidate the personal identification number (ACT S23). That is, in the present embodiment, the personal identification number is only valid during the specified period.

In case that the specified period does not pass after the personal identification number is received (No in ACT S14), if the personal identification number is inputted by the input unit 309 (Yes in ACT S15), the CPU 342 judges whether or not the input personal identification number matches with the personal identification number received in ACT S11 (ACT S16). The input of the personal identification number by the input unit 309 may be carried out by the keyboard and may also be carried out by reading the bar code. If the input personal identification number is judged to match with the received personal identification number (Yes in ACT S16), the CPU 342 enables the locking device 320 to unlock the door 303 (ACT S17). When the detection result of the content that the unlocking is detected is input from the detection sensor 353, the CPU 342 sends the status information denoting that the door 303 is in an unlocked state to the store computer 281 (ACT S18). Afterwards, the CPU 342 waits that the door 303 is locked (No in ACT S19).

Herein, by unlocking the door 303, the user can open the door 303 to take the collection cassette 260 and the collection bag 290 into the cashbox apparatus 301. The user puts the collection cassette 260 taken out from the automatic change dispensing machine 241 into the specified individual storage unit 310I and closes the door 303 after the collection bag 290 is put into the coin storage unit 310f. At the moment, the user previously puts the coin dispensed from the automatic change dispensing machine 241 into the collection bag 290. At the moment, the detection sensor 356 arranged at the individual storage unit 310I receiving the collection cassette 260 detects the collection cassette 260 and inputs the detection result into the CPU 342. The detection sensor 354 detects the closing state of the door 303 and inputs the detection result into the CPU 342.

When the detection result that the closing state of the door 303 is detected is input from the detection sensor 354 to the CPU 342, the CPU 342 enables the locking device 320 to lock the door 303. If the detection result in which the locking is detected is input from the detection sensor 353 to the CPU 342 to recognize the locking (Yes in ACT S19), the CPU 342 sends the status information indicating that the door 303 is in the locked state to the store computer 281 (ACT S20). In the status information, as an example, information that the processing has been normally completed, the specific information of the collection cassette 260 and locking date and time information are included.

The store computer 281 receiving the status information sends collection report information including the status information, the shop clerk number (person in charge) carrying out the operation and the number of currencies (banknote and coin) data classified according to the denomination in the collection cassette 260 to the host computer 411. In addition, the host computer 411 discloses the collection report information to the user whose login is allowed. At the moment, limitation for the disclosure of the collection report information can be also set for each user. The host computer 411 sends the storage status of the collection cassette 260 in the cashbox apparatus 301, which is acquired from the status information, to the security company computer 511. Thus, the security company 501 can recognize the status in the cashbox apparatus 301.

If it is judged that the personal identification number is not match in ACT S16 (No in ACT S16), the CPU 342 judges whether or not the number of input actions of the personal identification number in ACT S15 reaches a specified number of times (such as three times) after the personal identification number is received (ACT S21). The CPU 342 stores the number of input actions of the personal identification number in ACT S15 in the RAM 344. If the number of input actions of the personal identification number in ACT S15 do not exceed the specified number of times (No in ACT S21), the CPU 342 returns to ACT S15. On the other hand, if the number of input actions of the personal identification number exceed the specified number of times (Yes in ACT S21), the CPU 342 executes an error processing in ACT S22. As an example, the error processing is carried out such that the declaration in which the input of the personal identification number is not accepted is displayed on the display 307 and the received personal identification number is canceled from the RAM 344 to invalidate the personal identification number.

As described above, in the present embodiment, as an example, since the output section 342c outputs the status (the locking/unlocking status) of the door 303, the store 201 or the integration section 401 and the security company 501 can grasp the status of the door 303.

In addition, in the present embodiment, the POS terminal 211 is described as an example of the information processing apparatus generating a personal identification number, but it is not limited to that. The information processing apparatus generating a personal identification number may be the automatic change dispensing machine 241. In such a case, as an example, the automatic change dispensing machine 241 may generate a personal identification number according to a requirement from an external apparatus such as the POS terminal 211 and the like, and sends the personal identification number to the external apparatus. At the moment, it may also be constructed such that the personal identification number is encoded by respective encoding keys, registered beforehand, which are mutually different from one another for each external apparatus, and so long as it is not the external apparatus of a request source, the decoding cannot be carried out.

### A Second Embodiment

In the following second embodiment, portions of the second embodiment different from the first embodiment are mainly described.

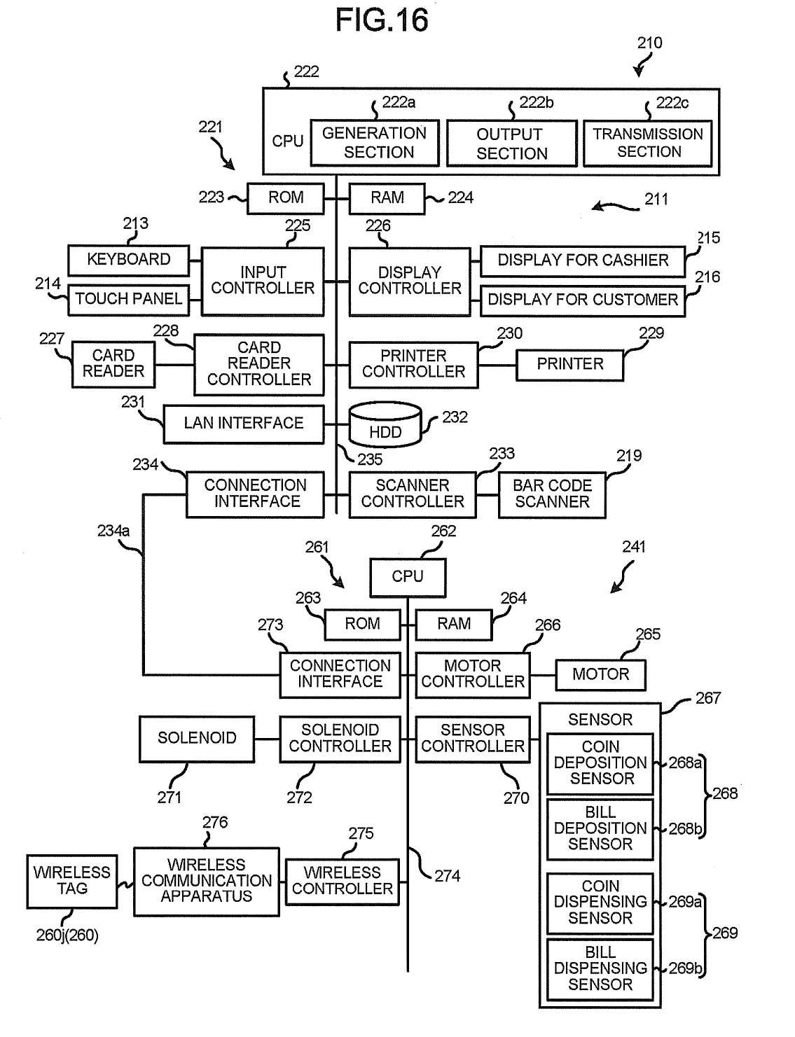

FIG. 16 is a block diagram illustrating the hardware structure of the checkout apparatus 210 according to the present embodiment. As shown in FIG. 16, the CPU 262 of the automatic change dispensing machine 241 of the present embodiment is connected with a wireless communication apparatus 276 through a bus line 274 and a wireless controller 275. The wireless communication apparatus 276 is an example of the output apparatus. The wireless communication apparatus 276 is built in the bill depositing and dispensing unit 241b. Moreover, a wireless tag 260j acting as an information storage medium (wireless storage medium) is attached to the collection cassette 260 of the present embodiment. The wireless tag 260j has an IC chip, a storage section and an antenna. The wireless communication apparatus 276 carries out short-distance wireless communication with the wireless tag 260j which is attached to the collection cassette 260 of the bill depositing and dispensing unit 241b. The wireless communication is carried out by utilizing a frequency used in RFID (Wireless Frequency Identification).

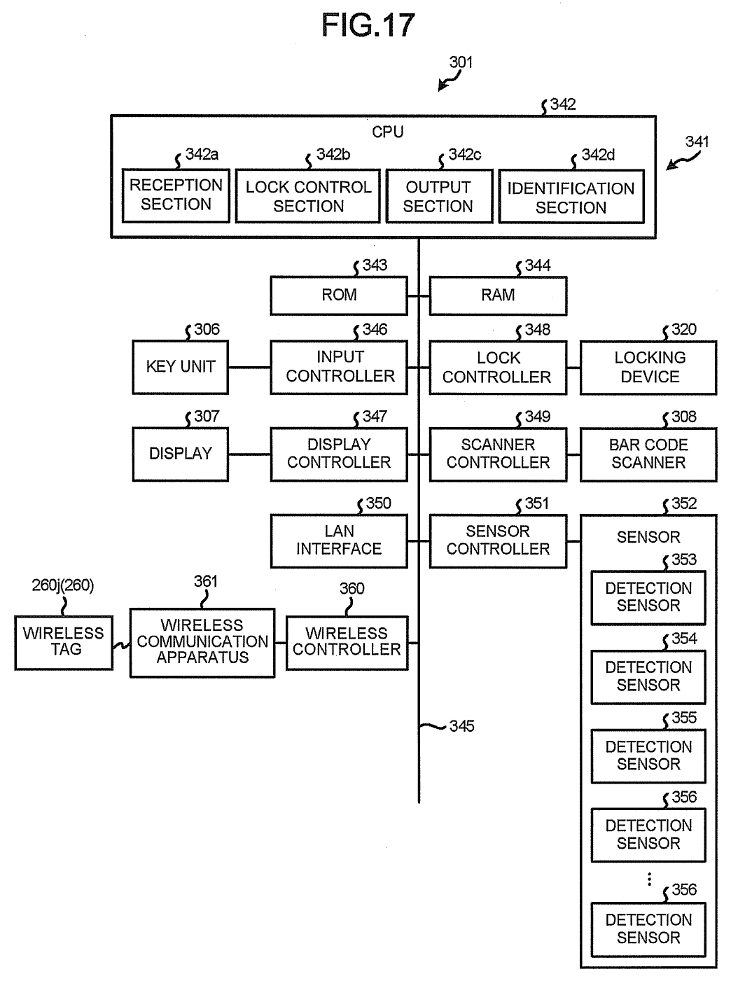

FIG. 17 is a block diagram illustrating the hardware structure of the cashbox apparatus 301 according to the present embodiment. The CPU 342 of the cashbox apparatus 301 of the present embodiment is connected with a wireless communication apparatus 361 through the bus line 345 and a wireless controller 360. The wireless communication apparatus 361 is an example of the input apparatus. The wireless communication apparatus 361, for example, is provided on the front surface 302a (referring to FIG. 7) of the main body unit 302, and carries out the short-distance wireless communication with the wireless tag 260j of the collection cassette 260 positioned on the front surface of the cashbox apparatus 301. The wireless communication is carried out by utilizing the frequency used in the RFID. The wireless communication apparatus 361 reads out a personal identification number stored in the wireless tag 260j and the specific information of the collection cassette 260 and inputs them into the CPU 342.

Next, the currency collection processing (the personal identification information output processing and the collection processing) in the cashbox system 209 with the above structure is described.

The CPU 222 of the POS terminal 211 of the present embodiment sends the specific information of the collection cassette 260 together with the personal identification number to the cashbox apparatus 301 in ACT S2 (referring to FIG. 14) in the personal identification information output processing. Moreover, in ACT S3 (referring to FIG. 14), the CPU 222 outputs the specific information of the collection cassette 260 together with the personal identification number to the wireless tag 260j. Particularly, the CPU 222 enables the wireless communication apparatus 276 to write the personal identification number and the specific information of the collection cassette 260 in the wireless tag 260j.

On the other hand, the CPU 342 of the cashbox apparatus 301 of the present embodiment receives the specific information of the collection cassette 260 together with the personal identification number from the POS terminal 211 in ACT S11 (referring to FIG. 15) in the collection processing, and stores the specific information of the collection cassette 260 and the personal identification number in the RAM 344 in ACT S12. In ACT S15, the personal identification number and the specific information of the collection cassette 260 are input from the wireless communication apparatus 361.

Afterwards, in ACT S16, the CPU 342 enables the locking device 320 to unlock the door 303 if the personal identification number received from the POS terminal 211 matches with the personal identification number input from the wireless communication apparatus 361, and further, the specific information of the collection cassette 260, which is received from the POS terminal 211, matches with the specific information of the collection cassette 260, which is input from the wireless communication apparatus 361. That is, the CPU 342 of the present embodiment enables the locking device 320 to carry out the unlocking in case that the personal identification information generated by the generation section 222a matches with the personal identification information input by the wireless communication apparatus 361, and further, the specific information of the collection cassette 260, which is input by the wireless communication apparatus 361, matches with the specific information associated with the personal identification information received by the receiving section 342a.

In the present embodiment described above, similar to the first embodiment, as an example, since the output section 342c outputs the status (the locking/unlocking status) of the door 303, the store 201, the integration section 401 and the security company 501 can recognize the status of the door 303.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A cashbox system, comprising:
a cashbox apparatus including a storage unit configured to receive a currency storage tool for storing currency, a door configured to open and close the storage unit, a locking device configured to lock and unlock the door, a detection section configured to detect the status of the door and an input section configured to input a first personal identification information;
a generation section configured to generate a second personal identification information;
a first output section configured to output the personal identification number generated by the generation section;
a lock control section configured to enable the locking device to unlock if the second personal identification information generated by the generation section matches with the first personal identification information input by the input section; and
a second output section configured to output the detection result of the detection section.

2. The cashbox system according to claim 1, comprising:
an information processing apparatus configured to be capable of communicating with the cashbox apparatus, wherein
the information processing apparatus includes the generation section, the first output section and a transmission section configured to send the second personal identification information generated by the generation section to the cashbox apparatus,
the cashbox apparatus including a reception section configured to receive the second personal identification information sent by the transmission section, the lock control section and the second output unit, and
the second output unit configured to send the detection result of the detection section to an external apparatus of the cashbox apparatus.

3. The cashbox system according to claim 2, wherein
the detection section detects the locking and the unlocking of the door; and
the second output section sends an information denoting the locking/unlocking state of the door to the external apparatus if the locking/unlocking state of the door changes.

4. The cashbox system according to claim 1, wherein
the first output section outputs a personal identification information ticket showing the second personal identification information generated by the generation section to a printer.

5. The cashbox system according to claim 4, wherein
the personal identification information ticket shows a code symbol of the second personal identification information, and
the input section reads the code symbol.

6. The cashbox system according to claim 1, wherein
the currency storage tool includes an information storage medium,
the first output section outputs the second personal identification information to the information storage medium, and
the input unit reads out the second personal identification information from the information storage medium.

7. The cashbox system according to claim 6, wherein
the information storage medium carries out a wireless communication with the input unit.

8. The cashbox system according to claim 2, wherein
the generation section associates the second personal identification information with specific information for specifying the currency storage tool;
the input section inputs the specific information; and
the lock control section enables the locking device to unlock the door if the second personal identification information generated by the generation section matches with the first personal identification information input by the input section, and further, the specific information input by the input section matches with the specific information associated with the second personal identification information received by the reception section.

9. A cashbox apparatus, comprising:
a storage unit configured to store a currency storage tool storing a currency;
a door configured to open and close the storage unit;
a locking device configured to lock and unlock the door;
a detection section configured to detect the status of the door;
an input section configured to input a first personal identification information;
a lock control section configured to enable the locking device to unlock the door if a second personal identification information generated by a generation section matches with the first personal identification information input by the input section; and
an output section configured to output the detection result of the detection section.

10. An management method executed by a cashbox apparatus comprising a storage unit for receiving a currency storage tool storing a currency, a door for opening and closing the storage unit, a locking device for locking and unlocking the door, a detection section for detecting the status of the door, and an input section for inputting a first personal identification information, including:
enabling the locking device to unlock the door if a second personal identification information generated by a generation section matches with the first personal identification information input by the input section; and
outputting the detection result of the detection unit.
